(19) United States
(12) Patent Application Publication
(10) Pub. No.: US 2013/0247136 A1
(43) Pub. Date: Sep. 19, 2013

(54) Automated Validation of Configuration and Compliance in Cloud Servers

(71) Applicants: Trieu C. Chieu, Scarsdale, NY (US); Shantanu Dutta, Bangalore (IN); Ashu Gupta, Hyderabad (IN); Angela McKay, Greenock (GB); Bob Prysock, Amsterdam (NL); Ratnasagar Ramaratnam, Ramapuram (IN); Anees A. Shaikh, Yorktown Heights, NY (US); Manas Singh, Elmsford, NY (US); Chunqiang Tang, Ossining, NY (US); Mahesh Viswanathan, Yorktown Heights, NY (US)

(72) Inventors: Trieu C. Chieu, Scarsdale, NY (US); Shantanu Dutta, Bangalore (IN); Ashu Gupta, Hyderabad (IN); Angela McKay, Greenock (GB); Bob Prysock, Amsterdam (NL); Ratnasagar Ramaratnam, Ramapuram (IN); Anees A. Shaikh, Yorktown Heights, NY (US); Manas Singh, Elmsford, NY (US); Chunqiang Tang, Ossining, NY (US); Mahesh Viswanathan, Yorktown Heights, NY (US)

(73) Assignee: INTERNATIONAL BUSINESS MACHINES CORPORATION, Armonk, NY (US)

(21) Appl. No.: 13/419,591

(22) Filed: Mar. 14, 2012

(51) Int. Cl. G06F 21/00; G06F 15/177

(52) U.S. Cl. 726/1; 709/220

(57) ABSTRACT

A method, an apparatus and an article of manufacture for automated validation of compliance in a cloud server. The method includes remotely accessing a target cloud server to discover at least one configuration setting of the target cloud server, integrating the at least one configuration setting from the target cloud server with information from at least one back-end tool to produce compliance evidence, and automatically answering a set of at least one checklist question for activation compliance validation of the target cloud server based on the compliance evidence.

### FIELD OF THE INVENTION

Embodiments of the invention generally relate to information technology (IT), and, more particularly, to server configuration and compliance.

### BACKGROUND

Validation of server configuration and compliance at the time of service activation is part of service management process and governance in most IT delivery organizations to ensure that security risks, governance controls and vulnerabilities are proactively managed through the lifecycle of the service. It also guarantees that all discovered problems are remediated for quality assurance before the service is delivered to customers. In existing approaches, the validation process is typically carried out through manual steps that are time consuming and error prone. This lengthy process is particularly troublesome when providing managed cloud servers to enterprise customers with a pre-specified request fulfillment time in a service-level agreement (SLA). In order to improve the timeliness and accuracy with which cloud services may be realized, a need exists for a system to orchestrate the processes for implementation and validation of configuration and compliance.

### SUMMARY

In one aspect of the present invention, techniques for automated validation of configuration and compliance in cloud servers are provided. An exemplary computer-implemented method for automated validation of compliance in a cloud server can include steps of remotely accessing a target cloud server to discover at least one configuration setting of the target cloud server, integrating the at least one configuration setting from the target cloud server with information from at least one back-end tool to produce compliance evidence, and automatically answering a set of at least one checklist question for activation compliance validation of the target cloud server based on the compliance evidence.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and operative to perform noted method steps. Yet further, another aspect of the invention or elements thereof can be implemented in the form of means for carrying out the method steps described herein, or elements thereof; the means can include (i) hardware module(s), (ii) software module(s), or (iii) a combination of hardware and software modules; any of (i)-(iii) implement the specific techniques set forth herein, and the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram of a cloud provisioning environment, according to an aspect of the invention;

FIG. 2 is a block diagram illustrating an example embodiment, according to an aspect of the invention;

FIG. 3 is a block diagram illustrating components of an automation engine, according to an aspect of the invention;

FIG. 4 is a diagram illustrating an example process flow sequence for server validation, according to an embodiment of the invention;

FIG. 5 is a diagram illustrating an example of component interaction for automated provisioning and activation of a server, according to an embodiment of the invention;

FIG. 6 is a flow diagram illustrating techniques for automated validation of compliance in a cloud server, according to an embodiment of the invention; and

FIG. 7 is a system diagram of an exemplary computer system on which at least one embodiment of the invention can be implemented.

### DETAILED DESCRIPTION

As described herein, an aspect of the present invention includes automated validation of configuration and compliance in managed cloud servers. At least one embodiment of the invention includes orchestrating a sequence of process steps to remotely access a target server to discover configuration settings, and integrating with various back-end tools and databases to correlate and validate for compliance. In an example embodiment of the invention, an automation system utilizes sets of executable scripts to discover the various configuration and security settings in the servers depending on their OS platform and pre-installed software stacks. These scripts can be managed in a local data store of the automation engine, and can be retrieved and packaged on-demand to be remotely executed in the target server.

As further detailed herein, the automation engine will collect and correlate the discovered information from the target server with that from other back-end tools, and use the resulting information as evidences to answer and compose a set of checklist questions for activation validation. Additionally, at least one embodiment of the invention can include a mechanism to remedy the interference between the scripts of software stacks and operating system (OS) scripts.

The techniques described herein include validating compliance (security, asset registration, risk management, etc.) at the time of creating a physical or virtual machine, and independent of whether a network zone is configured properly so that it can function properly. As detailed herein, at least one embodiment of the invention includes using an engine to orchestrate a workflow sequence and to drive integration with other tools that cannot be performed by scripts.

To ensure that all servers are set up according to an enterprise security standard and that all required activities-related evidence is retained for the correct period of time, at least one embodiment of the invention includes implementing the following activation rules in a managed cloud environment:
Every service activation has to follow a standard activation and governance process;
For every type of service activation, a corresponding activation checklist (server platform or software bundle) for the server has to be created and validated;
Full approvals of all of the checklists are required by an account executive before delivering services to customers; and
Approved checklists are to be maintained and archived in a repository as evidence for audit.

An activation checklist for a managed server facilitates delivery personnel in implementing and verifying the service objectives on a managed server based on a contract and/or a SLA. Each managed environment may impose different checklists for each type of service being managed in order to maintain and ensure consistency. By way of example, an embodiment of the invention includes implementing, in a managed environment for cloud provisioning, several standard checklists for activation of managed servers depending on whether or not additional software stacks are installed in the servers. Each type of checklist includes a set of standard questions to be answered satisfactorily. By way merely of example, checklist questions can include the following:
Have you completed the final security health check prior to making this device or subsystem generally available and ensured that all system settings are set in accordance with the agreed security governing standard for this account?
Have you successfully applied all available security systems patches on the device or subsystem being installed?
Have you correctly recorded the device or subsystem in the appropriate asset inventory databases?
Have you confirmed that operating system logging or subsystem logging has been enabled, and that the logs are being retained for the specified period of time according to the governing security policy for this account?

Additionally, as described herein, functions that the back-end management tools and databases support can include, for example, the following:
Risk and Issue Management Tool: Maintaining account profiles and service incidents for enterprise customers.
Asset Management Tool: Managing asset inventory for all activated servers.
Security Management Tool: Registering and maintaining server information to provide regular security health checks.
ID Management Tool: Registering and maintained customer identifiers (IDs) shared inside the activated servers.
Checklist Repository Database: Maintaining and archiving checklist evidences for activated servers for compliance audit purpose.

Cloud computing can provide lower costs due to economies of scale. To achieve low cost, manual processes associated with systems management and provisioning can be eliminated. Also, cloud computing provides a self-service environment for requesting compute resources. Thus, cloud technology automates the provisioning processes by delivering the computing resources as virtual machines with software stacks to users via networks.

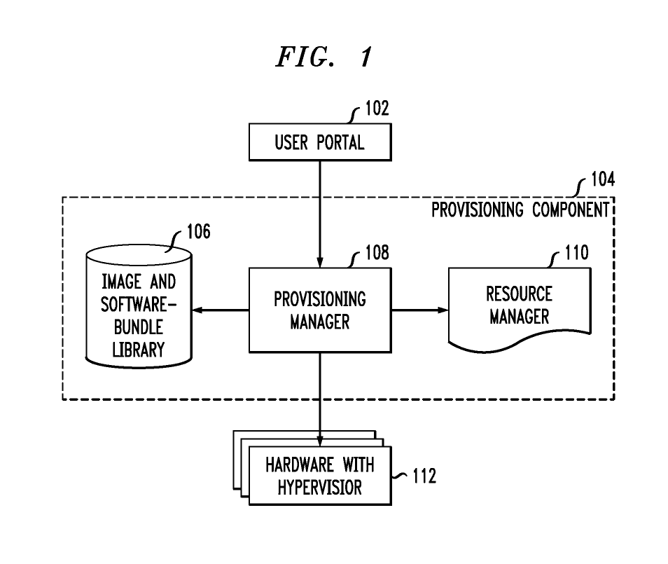

FIG. 1 is a block diagram of a cloud provisioning environment, according to an aspect of the invention. By way of illustration, FIG. 1 depicts a user portal 102, a provisioning component 104 that includes an image and software-bundle library 106, a provisioning manager 108 and a resource manager 110, and hardware with a hypervisor 112. Typically, service providers create a pool of networked hardware resources. Each hardware resource runs virtualization software or a hypervisor, and a hypervisor enables each hardware resource to host and run multiple virtual machines. The cloud resources are made available to users through a user portal 102 or web services application programming interfaces (APIs). User requests are forwarded to a provisioning manager component 108 that performs the following tasks:

1) Refers to a resource manager component 110 to locate a hardware resource that has available capacity to run the virtual machine that the user requested;

2) Copies the image for the virtual machine from an image library 106 to the target hardware resource;

3) Creates the configuration for the virtual machine on the target hardware resource and creates the virtual machine;

4) Installs additional software using installable(s) from the software-bundle library 106; and

5) Notifies the user after the virtual machine has been successfully created.

An image is the disk representation of a virtual machine pre-installed with an operating system and is used as a template from which multiple copies can be instantiated as virtual machine (VM) instances. A VM instance can include two files: the configuration file, and the actual disk image. The configuration file represents the metadata pertaining to location of the disk image file, display name, attached network and peripheral devices.

Cloud Computing uses images as the building blocks for provisioning. When a user requests a compute resource, the provisioning manager component 108 locates and retrieves the appropriate image from the image library 106, and uses the image to create the new virtual machine. The capabilities provided by the cloud can be abstracted in the infrastructure as a service layer.

Additionally, a software bundle is an installable for a collection of software packages that can be installed and configured automatically in a server. In at least one embodiment of the invention, a cloud provisioning system may use software bundles to install middleware and/or applications on different operating system (OS) platforms to provide complete software appliances.

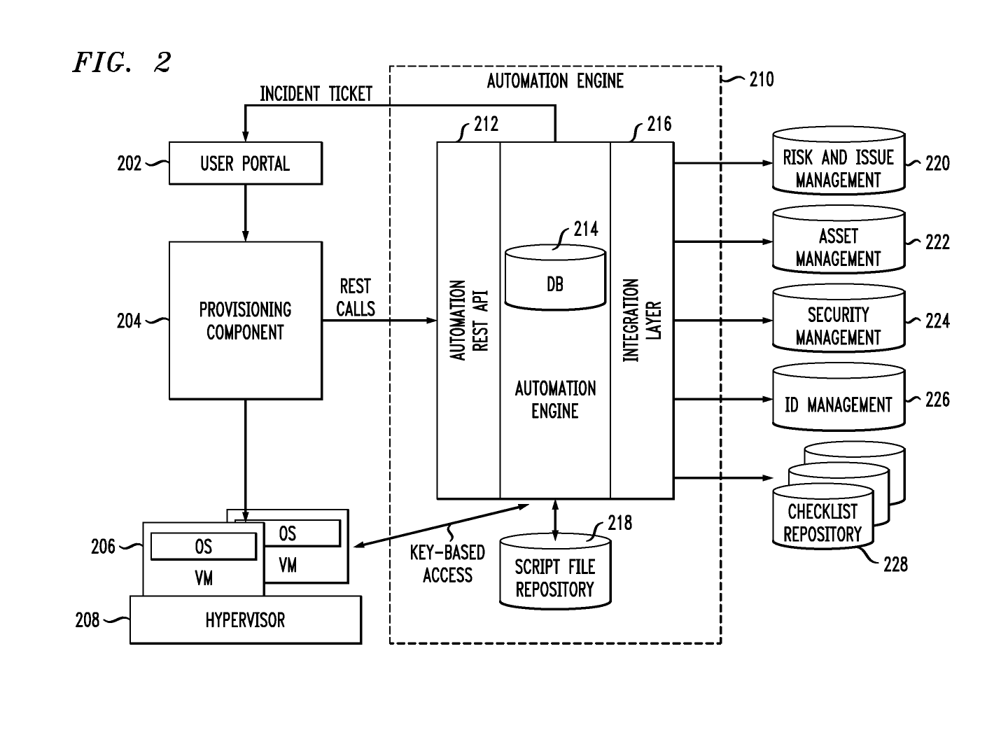

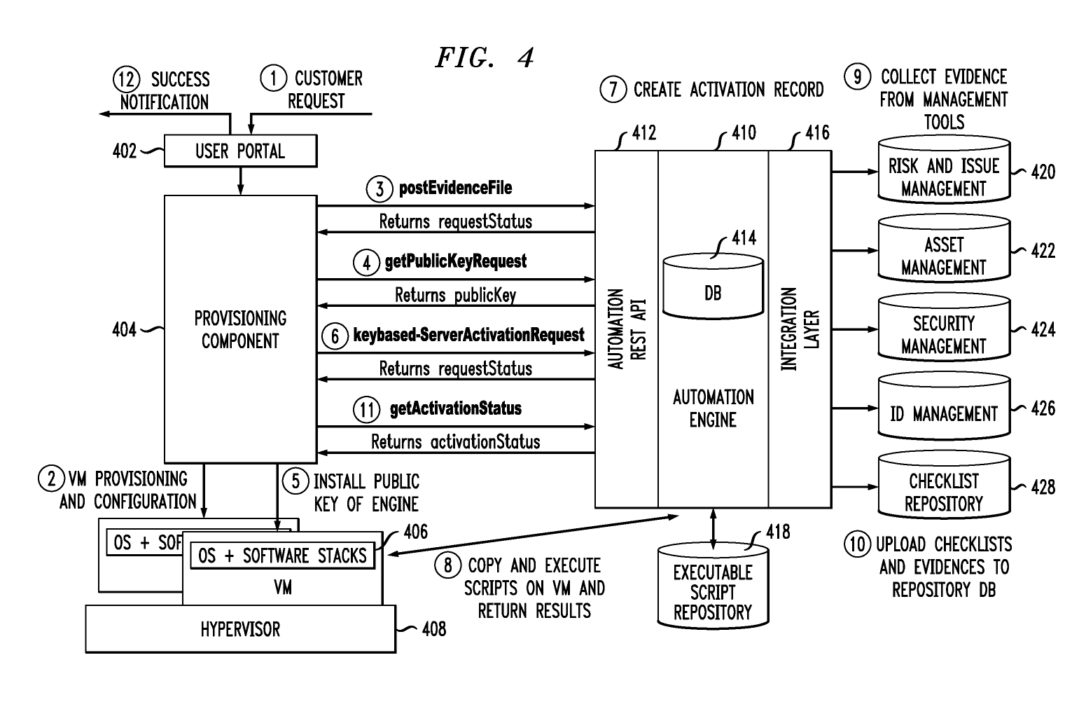

FIG. 2 is a block diagram illustrating an example embodiment, according to an aspect of the invention. By way of illustration, FIG. 2 depicts a user portal 202, a provisioning component 204, an OS/virtual machine (VM) 206 and a hypervisor 208. FIG. 2 also depicts an automation engine 210, which includes an automation representational state transfer (REST) API 212, an automation engine database 214, an integration layer 216 as well as a script file repository 218. FIG. 2 additionally depicts a risk and issue management database 220, an asset management database 222, a security management database 224, an ID management database 226 and a checklist repository 228. The flow of data depicted in FIG. 2 is further illustrated in FIG. 4.

The components of the system depicted in FIG. 2 carry out tasks such as the following: managing scripts for the image sets and software bundles, orchestrating the workflow process for evidence collection from a cloud server (VM), integrating with back-end management tools and databases to collect further evidences, verifying and correlating all evidences to compose the activation checklists, and submitting the checklists with evidences to a checklist repository for final approval processing and archiving.

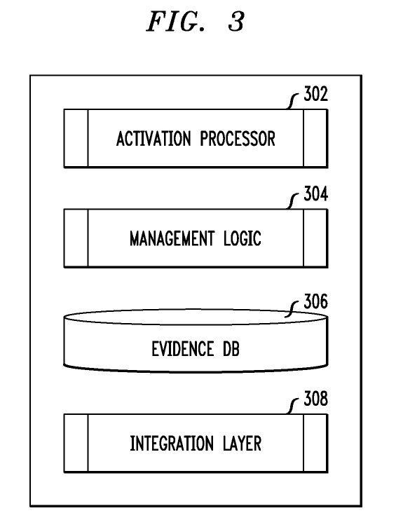

As detailed herein, an automation system 210 of at least one embodiment of the invention is designed to function with a cloud provisioning system 204 on separated logic, interact with multiple back-end tools and databases for querying them, store response state and retrying with timeout using efficient multiple connections, and parse evidences to generate answers and evidences for checklist questions. An engine exposes a set of restful APIs 212 based on hypertext transfer protocol secure (HTTPS) protocol to allow an external provisioning system to invoke upon service activation. Additionally, the automation engine can be implemented, for example, as a J2EE application with several internal components, such as those illustrated in FIG. 3.

Another component of the automation system depicted in FIG. 2 is the script repository 218, which is an organized file system to store all of the scripts corresponding to different operation systems and software bundles. Scripts are executables to be executed in VMs, and these scripts are responsible for performing various tasks in order to collect configuration and security settings of the VM as evidences for answering corresponding checklist questions. Scripts can be organized in the form of script-let for collecting evidence for each target question. As evidences in some checklist questions, the scripts are responsible for verifying that the required software agents for connecting to back-end management tools are successfully installed and running in the VM. In other instances, the scripts may perform direct queries in remote tools to gather evidences.

The executable scripts can be developed based on the OS platform and middleware/software applications. Typically, each set of scripts is developed for each OS platform and/or middleware.

In order to enable an automation system such as depicted in FIG. 2 to remotely access the provisioned VM to execute for evidence collection, a remote, password-less, key-based secure-shell mechanism is implemented in the cloud provisioning environment. A key-based access mechanism includes the generation of a RSA public-private key-pair in the host of the automation system. Subsequently, the public key of the automation engine is installed into each remote VM before invoking any API call. Because only the cloud provisioning system has initial control and access to the provisioned VM, it is thus required that the provisioning system should assist in retrieving and installing the engine's public key into the VM.

To facilitate the invocation of the activation services by an external client system, an automation system in accordance with at least one embodiment of the invention is designed with a set of restful APIs based on the secure hypertext transfer protocol secure (HTTPS) protocol. Because the execution of scripts, evidence collection, back-end database queries, and checklist composition may take a long period of time, the activation process and status request are designed to be invoked in separate calls.

The APIs are thus implemented with a required unique request ID parameter and with database persistence in order to maintain and allow tracking of the running state of each request. Examples of activation APIs can include the following:
/ActivationAPI/postEvidenceFile/<serverHostName>—A HTTP POST command to post an external evidence file (related to the service activation for the given <serverHostName> and generated by an external system) to the engine to be used when composing the final checklist.
/ActivationAPI/getPublicKeyRequest—To retrieve and return the public key string of the automation engine.
/ActivationAPI/keybasedActivationRequest/<reqID>/<OSPlatform>/<serverHostName>—To initiate an activation process for a given server with a given unique <reqID>, <serverHostName> and <OSPlatform>.
/ActivationAPI/getActivationStatusRequest/<reqID>—To poll and return the final activation status and checklists of the previous request with given <reqID>.

FIG. 3 is a block diagram illustrating components of an automation engine, according to an aspect of the invention. As detailed herein, the internal components of an automation engine include an activation processor 302 to serve the restful APIs, a workflow management logic component 304 to manage a local database and script repository, as well as remote access logic to enable remote connection to VM for script execution. The management logic component 304 is also responsible for parsing the collected evidences and composing answers and evidences for checklist questions. The components additionally include a local evidence database (DB) 306 to persist the state of the activation process, and an integration layer 308 to interact with back-end management tools and databases for querying them, storing response state and retrying with timeout using concurrent connections.

FIG. 4 is a diagram illustrating an example process flow sequence for server validation, according to an embodiment of the invention. By way of illustration, FIG. 4 depicts a user portal 402, a provisioning component 404, an OS/virtual machine (VM) 406 and a hypervisor 408. FIG. 4 also depicts an automation engine 410, which includes an automation representational state transfer (REST) API 412, an automation engine database 414, an integration layer 416 as well as a script file repository 418. FIG. 4 additionally depicts a risk and issue management database 420, an asset management database 422, a security management database 424, an ID management database 426 and a checklist repository 428.

FIG. 4 also illustrates the sequence of steps from start to completion for the activation process of a cloud VM server in accordance with an example embodiment of the invention. In step 1, a server activation request is first triggered from a server request by a customer at the user portal 402. The request is passed to the provisioning component 404 for provisioning actions (for example, creation and configuration of the cloud server). After completion of VM provisioning and configuration in step 2, step 3 includes the provisioning component 404 posting all related evidences for the VM to the automation engine 410 by invoking the “postEvidenceFile” API as many times as needed for all evidence files.

To enable the automation engine to access the provisioned VM without password, the provisioning component 404 retrieves the public key string of the automation engine using the “getPublicKeyRequest” API in step 4, and installs the public key into the VM to allow shared admin ID access to the VM in step 5. Also, the provisioning component 404 invokes the “keybasedServiceActivationRequest” API to initiate the server activation process in step 6, and polls the status of the activation request until “success” or “fail” using the “getActivationStatus” API call in step 11, and returns the request status back to the user portal.

Internal processing of the server activation request will start as soon as the “keybasedServiceActivationRequest” request is received by the engine 410. Step 7 includes creating an activation record in its local database, checking the remote connection to the VM using the engine's private key as the credential for a shared admin ID, and initiating a separate background process for server activation. Once the connection to VM is verified, the corresponding activation scripts for the image type of the VM will be retrieved, copied and executed in the VM to return the results of evidences in step 8. Additional queries to back-end management tools and databases (such as databases 420, 422, 424 and 426 in FIG. 4) can also be carried out to collect further evidences in step 9. Step 10 includes final checklist composition including answers and evidence to all questions, storing the information in a database, updating the successful activation status, and uploading the results to a back-end checklist repository 428. Also, update of local activation status can occur once the validation process is completed successfully. After getting a “success” or “fail” activation status, the user portal sends the success notification back to the requester to complete the service activation request in step 12.

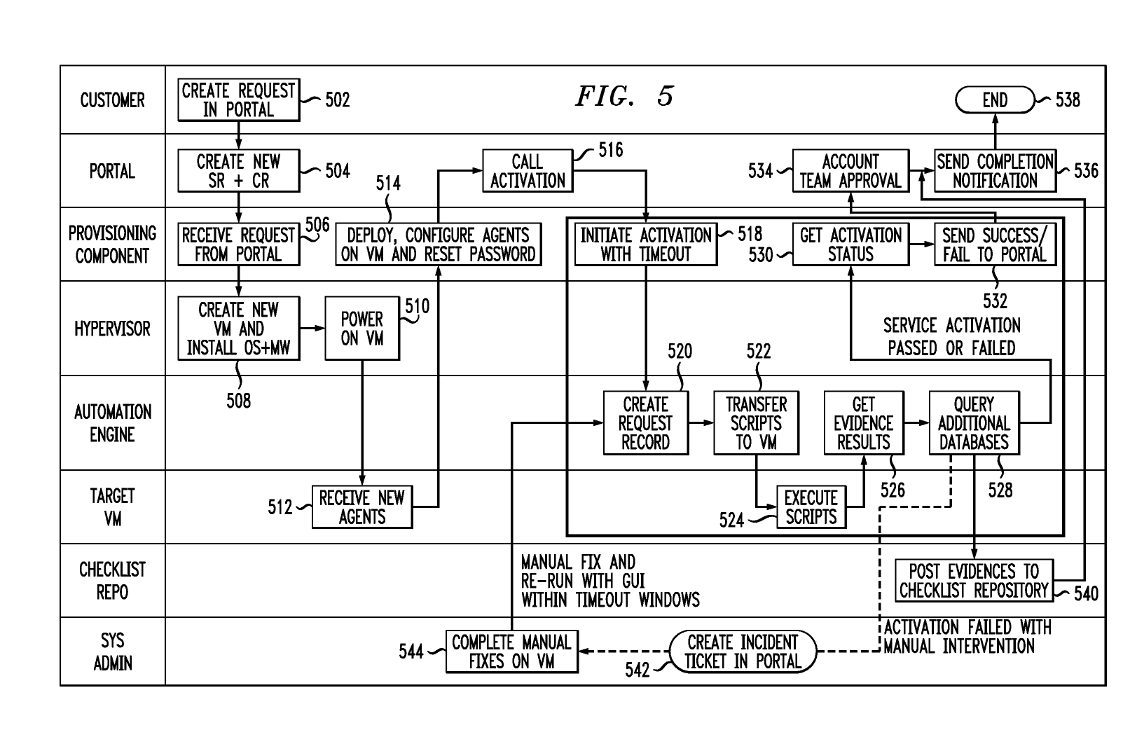

FIG. 5 is a diagram illustrating an example of component interaction for automated provisioning and activation of a server, according to an embodiment of the invention. Step 502 includes a customer creating a request in a user portal. Step 504 includes creating a new service request (SR) and change request (CR) (via the portal). Step 506 includes receiving the request from the portal (at the provisioning manager/component level). Via a hypervisor, step 508 includes creating a new VM and installing the OS and middleware (MW). Additionally, step 510 includes powering on the VM.

Step 512 includes the target VM receiving new agents, and step 514 includes deploying and configuring agents on the VM and resetting the password (at the provisioning manager/component level). Further, step 516 includes calling activation via the portal.

Within the automation engine, step 518 includes initiating activation with a timeout, step 520 includes creating a request record and step 522 includes transferring scripts to the VM. Additionally, step 524 includes executing the scripts, step 526 includes obtaining evidence results and step 528 includes querying additional databases. Further, step 530 includes obtaining an activation status and step 532 includes sending a success/fail message to the portal.

Additionally, step 540 includes posting evidences to a checklist repository. Also, step 542 includes creating an incident ticket in the portal when any error is found in checklist answers and step 544 includes completing manual fixes on the VM, both of which are carried out by a system admin. Further, at the portal, step 534 includes providing account team approval and step 536 includes sending a completion notification to the customer, which ends the sequence in step 538.

As detailed herein, because the OS and software or middleware stacks can be dynamically provisioned for a server by a provisioning system, multiple matching sets of scripts should be retrieved on-demand by the engine to be executed in a target server. Because the OS and middleware scripts are independently developed, they do not have a priori knowledge of their mutual existence, and thus cannot take into account their interference. Accordingly, an aspect of the invention includes a mechanism to account for this dynamic interference by using a policy file to capture the possible variables introduced by a software stack to their OS, and extracting this information at run-time to be passed to the OS scripts as inputs to avoid interference. These variables are readily obtainable because all software stacks are pre-created, standardized software bundles in a cloud provisioning system.

Additionally, as described herein, aspects of the invention also include verifying connectivity between a computing device and the back-end management tools and databases, registering the device in back-end management tools and databases, as well as supporting multiple customers' different compliance requirements using policies.

Embodiments of the invention can be applicable to multiple scenarios such as, for example, the following. For servers built from installable as in legacy server build process, an embodiment of the invention includes using extensible markup language (XML) policy file to capture all possible dependencies between automation scripts to handle configuration exceptions in servers provisioned from dynamic combination of platform and middleware bundles. Also, evidence results obtained from servers are checked and verified automatically by the engine to generate checklist answers, and all compliant checklists are stored and managed by the automation system in a single place for audit purposes.

For servers provisioned using static server image in a virtualized environment, an embodiment of the invention includes taking advantage of the characteristics of servers provisioned based on a static server image to simplify the subsequent validation process at time of provisioning new servers. For example, some compliance configuration can be preconfigured in the base image for compliance with requirements such as password policies, etc. so that dynamic checking of that configuration can be marked “not applicable” or “pre-answered,” and can be skipped at activation time.

For servers provisioned in a standardized cloud environment, an embodiment of the invention includes further taking advantage of a standardized cloud provisioning environment to simplify and streamline the process by eliminating unnecessary validation steps. This is because the server provisioning steps are standardized and are repetitive in exactly the same ways in a cloud environment. Thus, only dynamic configuration settings over the network to configuration tools and databases will remain to be checked and verified. Additionally, automation in a cloud environment will enable the automated sign-off to speed up the server release process without the need to have manual review and approval by account executive for the release of servers to customers.

As also detailed herein, for a cloud server that is installed with an OS platform and middleware, checklists and validation of configuration and compliance on both OS and middleware are usually required. Validation of a given OS platform or a given middleware configuration is typically carried out by standard OS scripts or middleware scripts developed for the given type of OS or middleware. For instance, for security validation, the OS scripts will check and confirm the configuration settings on password policies, user policies, file and folder permissions, etc., while the middleware scripts will validate the middleware access policies, middleware resource access permissions, etc.

In a typical security validation situation in which a server has no middleware, the OS scripts may have to confirm and pass the password expiry policy (for example, password expiration must be set to 90 days) on all predefined system admin users installed in the server without problem. However, with a server installed with middleware, a password non-expiry middleware system user may have to be added into the server, which will introduce a violation in password policy checked by the standard OS scripts, thus failing the OS checklist. Because the OS and middleware or software stacks can be dynamically provisioned for a server by a provisioning system, multiple matching sets of scripts should be retrieved on-demand by the engine to be executed in a target server. Also, because the OS and middleware scripts are independently developed, they do not have a priori knowledge of their mutual existence, and thus are unable to take into account their interference. In this situation, a means to signal this configuration exception to the standard OS scripts is necessary.

To handle this type of interference between independent OS and middleware scripts, an aspect of the invention includes a policy mechanism in the automation engine design to handle the possible exceptions, as detailed herein. The exceptions can be captured and stored in an exception policy file in XML format. This XML policy file will be parsed at run-time to compose an input file to the OS scripts, which only includes the exceptions required for the installed software bundles or middleware in the server.

Each platform and middleware may have its corresponding entry in the policy file to indicate its exception requirements. In one example, the optional exception for password non-expiry for each system user under <user> tag or the exception for access permission in home directory under <home> tag is specified under the <password> tag or <resource> tag, correspondingly. To support this policy mechanism, the OS scripts will have to be developed by taking into account the policy input parameters and skipping the validation checking accordingly.

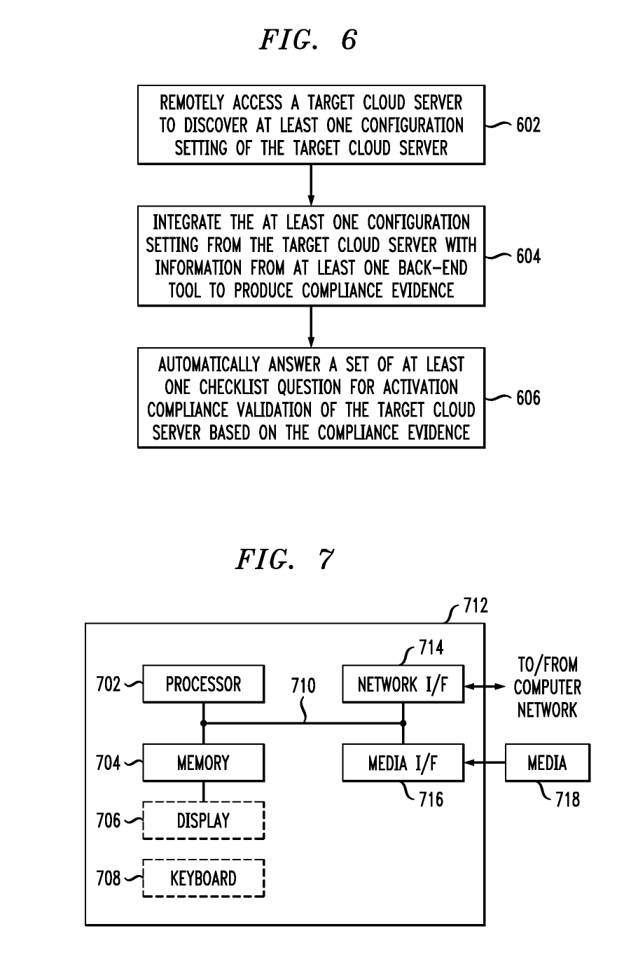

FIG. 6 is a flow diagram illustrating techniques for automated validation of compliance in a cloud server, according to an embodiment of the present invention. Step 602 includes remotely accessing a target cloud server to discover at least one configuration setting of the target cloud server. Remotely accessing a target cloud server can include retrieving a public key string of an automation engine and installing the public key into a virtual machine to allow shared access to the virtual machine. Also, remotely accessing a target cloud server to discover configuration settings of the target cloud server can include utilizing at least one set of executable scripts to discover the configuration settings in the target cloud server.

The set of executable scripts can be managed in a local database and can be retrieved and packaged on-demand to be remotely executed in the target cloud server. Also, the set of executable scripts can be executed in a managed server to discover the configuration setting for a required security policy. Additionally, the set of executable scripts can be used to discover the configuration setting for multiple platforms. Further, the set of executable scripts can include a set of standardized middleware scripts used to discover the configuration setting for different middleware software.

Step 604 includes integrating the at least one configuration setting from the target cloud server with information from at least one back-end tool to produce compliance evidence. The back-end tools can include, for example, an issue and risk management database, an asset management database, an identity management database, a security management database, and an incident management database.

Step 606 includes automatically answering a set of at least one checklist question for activation compliance validation of the target cloud server based on the compliance evidence.

The techniques depicted in FIG. 6 can also include capturing at least one exception rule to eliminate an interference between independent operating and middleware scripts at runtime. At least one embodiment of the invention can additionally include receiving a server activation request from a user. Also, the at least one checklist question for activation compliance validation of the target cloud server can be stored with corresponding supporting evidence in a checklist repository.

The techniques depicted in FIG. 6 can also, as described herein, include providing a system, wherein the system includes distinct software modules, each of the distinct software modules being embodied on a tangible computer-readable recordable storage medium. All the modules (or any subset thereof) can be on the same medium, or each can be on a different medium, for example. The modules can include any or all of the components shown in the figures. In an aspect of the invention, the modules can run, for example on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 6 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in a computer readable medium having computer readable program code embodied thereon.

An aspect of the invention or elements thereof can be implemented in the form of an apparatus including a memory and at least one processor that is coupled to the memory and operative to perform exemplary method steps.

Additionally, an aspect of the present invention can make use of software running on a general purpose computer or workstation. With reference to FIG. 7, such an implementation might employ, for example, a processor 702, a memory 704, and an input/output interface formed, for example, by a display 706 and a keyboard 708. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 702, memory 704, and input/output interface such as display 706 and keyboard 708 can be interconnected, for example, via bus 710 as part of a data processing unit 712. Suitable interconnections, for example via bus 710, can also be provided to a network interface 714, such as a network card, which can be provided to interface with a computer network, and to a media interface 716, such as a diskette or CD-ROM drive, which can be provided to interface with media 718.

Accordingly, computer software including instructions or code for performing the methodologies of the invention, as described herein, may be stored in an associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 702 coupled directly or indirectly to memory elements 704 through a system bus 710. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 708, displays 706, pointing devices, and the like) can be coupled to the system either directly (such as via bus 710) or through intervening I/O controllers (omitted for clarity).

Network adapters such as network interface 714 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 712 as shown in FIG. 7) running a server program. It will be understood that such a physical server may or may not include a display and keyboard.

As noted, aspects of the present invention may take the form of a computer program product embodied in a computer readable medium having computer readable program code embodied thereon. Also, any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the present invention may be written in any combination of at least one programming language, including scripting languages such as UNIX Shell Script, Perl Script, Windows VBScript or the like, an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. Accordingly, an aspect of the invention includes an article of manufacture tangibly embodying computer readable instructions which, when implemented, cause a computer to carry out a plurality of method steps as described herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 702. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

At least one aspect of the present invention may provide a beneficial effect such as, for example, automating the validation for compliance on configuration and security of a computing device that is provisioned from dynamic combination of software bundles.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for automated validation of compliance in a cloud server, wherein the method comprises:
remotely accessing a target cloud server to discover at least one configuration setting of the target cloud server, wherein said accessing comprises utilizing at least one set of executable scripts to discover the at least one configuration setting in the target cloud server, and wherein each set of executable scripts corresponds to one of a given operating system and a given set of software;
integrating the at least one configuration setting from the target cloud server with information from at least one back-end tool to produce compliance evidence; and
automatically answering a set of at least one checklist question for activation compliance validation of the target cloud server based on the compliance evidence;
wherein at least one of the steps is carried out by a computer device.

2. The method of claim 1, further comprising:
eliminating an interference between independent operating and middleware scripts at runtime based on one or more identified exceptions.

3. The method of claim 1, further comprising:
receiving a server activation request from a user.

4. The method of claim 1, further comprising:
storing the at least one checklist question for activation compliance validation of the target cloud server with corresponding supporting evidence in a checklist repository.

5. (canceled)

6. The method of claim 1, wherein the at least one set of executable scripts are managed in a local database and can be retrieved and packaged on-demand to be remotely executed in the target cloud server.

7. The method of claim 1, wherein the at least one set of executable scripts are executed in a managed server to discover the at least one configuration setting for a required security policy.

8. The method of claim 1, wherein the at least one set of executable scripts are used to discover the at least one configuration setting for multiple platforms.

9. The method of claim 1, wherein the at least one set of executable scripts comprise at least one set of standardized middleware scripts, and the at least one set of standardized middleware scripts are used to discover the at least one configuration setting for different middleware software.

10. The method of claim 1, wherein remotely accessing a target cloud server comprises retrieving a public key string of an automation engine and installing the public key into a virtual machine to allow shared access to the virtual machine.

11. The method of claim 1, wherein the at least one back-end tool comprises at least one of a provisioning component, an issue and risk management database, an asset management database, an identity management database, a security management database, and an incident management database.

12. An article of manufacture comprising a computer readable storage medium having computer readable instructions tangibly embodied thereon which, when implemented, cause a computer to carry out a plurality of method steps comprising:
remotely accessing a target cloud server to discover at least one configuration setting of the target cloud server, wherein said accessing comprises utilizing at least one set of executable scripts to discover the at least one configuration setting in the target cloud server, and wherein each set of executable scripts corresponds to one of a given operating system and a given set of software;
integrating the at least one configuration setting from the target cloud server with information from at least one back-end tool to produce compliance evidence; and
automatically answering a set of at least one checklist question for activation compliance validation of the target cloud server based on the compliance evidence.

13. The article of manufacture of claim 12, wherein the computer readable instructions which, when implemented, further cause a computer to carry out a method step comprising:
eliminating an interference between independent operating and middleware scripts at runtime based on one or more identified exceptions.

14. (canceled)

15. The article of manufacture of claim 12, wherein the at least one set of executable scripts are managed in a local database and can be retrieved and packaged on-demand to be remotely executed in the target cloud server.

16. The article of manufacture of claim 12, wherein the at least one set of executable scripts are executed in a managed server to discover the at least one configuration setting for a required security policy.

17. The article of manufacture of claim 12, wherein the at least one set of executable scripts comprise at least one set of standardized middleware scripts, and the at least one set of standardized middleware scripts are used to discover the at least one configuration setting for different middleware software.

18. The article of manufacture of claim 12, wherein the at least one back-end tool comprises at least one of a provisioning component, an issue and risk management database, an asset management database, an identity management database, a security management database, and an incident management database.

19. A system for automated validation of compliance in a cloud server, comprising:
at least one distinct software module, each distinct software module being embodied on a tangible computer-readable medium;
a memory; and
at least one processor coupled to the memory and operative for:
remotely accessing a target cloud server to discover at least one configuration setting of the target cloud server, wherein said accessing comprises utilizing at least one set of executable scripts to discover the at least one configuration setting in the target cloud server, and wherein each set of executable scripts corresponds to one of a given operating system and a given set of software;
integrating the at least one configuration setting from the target cloud server with information from at least one back-end tool to produce compliance evidence; and
automatically answering a set of at least one checklist question for activation compliance validation of the target cloud server based on the compliance evidence.

20. The system of claim 19, wherein the at least one processor coupled to the memory is further operative for:
eliminating an interference between independent operating and middleware scripts at runtime based on one or more identified exceptions.

21. (canceled)

22. The system of claim 19, wherein the at least one set of executable scripts are managed in a local database and can be retrieved and packaged on-demand to be remotely executed in the target cloud server.

23. The system of claim 19, wherein the at least one set of executable scripts are executed in a managed server to discover the at least one configuration setting for a required security policy.

24. The system of claim 19, wherein the at least one set of executable scripts comprise at least one set of standardized middleware scripts, and the at least one set of standardized middleware scripts are used to discover the at least one configuration setting for different middleware software.

25. The system of claim 19, wherein the at least one back-end tool comprises at least one of a provisioning component, an issue and risk management database, an asset management database, an identity management database, a security management database, and an incident management database.
